(19) United States
(12) Patent Application Publication
(10) Pub. No.: US 2003/0105966 A1
(43) Pub. Date: Jun. 5, 2003

(54) Authentication server using multiple metrics for identity verification

(76) Inventors: Eric Pu, Hayward, CA (US); Dong Won Lee, Saratoga, CA (US); Jun-Young Ahn, Palo Alto, CA (US); Rick Sadler, Ripon, CA (US); William Tong, Santa Cruz, CA (US); Haili Ma, San Jose, CA (US)

Correspondence Address: Douglas G. Hodder, Morrison & Foerster LLP, 755 Page Mill Road, Palo Alto, CA, 94304-1018, US

(21) Appl. No.: 10/139,661

(22) Filed: May 2, 2002

Related U.S. Application Data
(60) Provisional application No. 60/288,207, filed on May 2, 2001.

(51) Int. Cl. H04K 1/00; H04L 9/32; G06F 11/30; G06F 12/14; H04L 9/00

(52) U.S. Cl. 713/186; 713/201

(57) ABSTRACT

Disclosed is a system for authenticating a user on a computer network using multiple user metrics. The system includes a service provider, a client and an authentication server. The service provider provides a service to clients on the computer network. The client provides authentication information of the user prior to receiving services from the service provider. The authentication information includes at least a supplied user credential associated with the user of the client, a predetermined session code and an extracted biometric template representing biometric information associated with the user of the client. The authentication server verifies the identity of the user by analyzing the supplied user credential, the predetermined session code and the extracted biometric template.

### RELATED APPLICATIONS

The present application claims priority to U.S. Provisional Patent Application No.

60/288,207, filed May 2, 2001, entitled “Authentication Server Using Multiple Metrics for Identity Verification” by Eric Pu, Dong Won Lee, Rick Sadler, and William Tong, and incorporate that provisional application by reference.

### BACKGROUND

1. Technical Field

The present invention relates to verification of identity on a distributed computer network. Specifically, the present invention includes a method and apparatus for using multiple metrics for identification of users on a network.

2. Related Art

The advent of the Internet has revolutionized ways in which society thinks and interacts. It presents users with completely new concepts in learning, communicating, collecting information, conducting business and spending leisure time, to name a few. However, the Internet is still relatively new, and some important areas remain problematic.

One example of an area which is not yet highly developed on the Internet is identity. It is still possible to remain anonymous on the Internet or for a user to pretend to be someone he or she is not. That a user can remain anonymous on the Internet can, in some situations, be of tremendous benefit, and may be a significant factor in the unparalleled success of the medium. However, in other situations, anonymity or the ability to counterfeit ones identity can be detrimental to the growth of the medium. For example in activities such as on-line shopping, banking, stock trading, contract negotiations and execution, confidential communications and numerous other types of internet interactions, it is desirable to have a high level of certainty that the party with which a user is dealing is who it claims to be. Uncertain identity in these situations has tended to stifle the use of the internet for these and similar purposes.

One approach to verification of claimed identity on the Internet is the well understood use of digital certificates. Essentially, a trusted certificate authority verifies the identity of a user and issues to the user a digital certificate. A second user entering into a transaction with the first user can verify the first user's identity by either viewing the first user's digital certificate or having the first user forward a digital certificate (e.g. along with a contract) to the second user. A drawback with this approach is that someone wishing to pose as the first user need only get access to the first user's computer, in which the first user's certificate would typically be stored, or otherwise get access to the first user's digital certificate (if it is not stored in the first user's computer).

A second approach to authentication of identity on the Internet is discussed in U.S. Pat. No. 5,987,232, to Tabuki entitled “Verification Server for Use in Authentication on Networks” (“Tabuki”). Tabuki discloses a verification server networked with an application client and application server. The verification server stores biometric authentication data which is unique to a network user. When requested by the application server (with which the application client is undertaking a transaction requiring authenticated identity), the application client enters biometric information such as a signature or fingerprint. This biometric information, along with information about the application server requesting authentication, is transmitted to the verification server. The verification server does a search of the biometric authentication stored therein for a match of the entered biometric data. The verification server then sends results from the matching operation (e.g. verifies identity, does not verify identity, or requires additional biometric information) to the requesting application server.

By using a biometric of a user to identify the user, the authentication server of Tabuki makes it difficult for a second user wishing to impersonate a first user to do so simply by appropriating the password of the first user. Rather, the second user generally must have the fingerprint, voiceprint, signature or other biometric of the first user in order to impersonate the first user. Because the biometric represents an actual physical feature of a user (something the user is) rather than just something the user knows, it may be more difficult to impersonate a user on the biometric system of Tabuki than on a standard password based authentication system.

The authentication server outlined in Tabuki, however, uses only a single means, or metric, to identify a user. Specifically, the authentication server disclosed in Tabuki uses only a biometric of a user to authenticate the identity of the user. Thus, to the degree that a second user who wishes to impersonate a first user can mimic or otherwise access the biometric of the first user (which, in some cases, may be possible), the authentication server disclosed in Tabuki may permit the second user to successfully impersonate the first user.

### SUMMARY OF THE INVENTION

The present invention includes an authentication server which uses up to three distinct pieces of information or “metrics” to verify the identity of a user. The authentication server of the present invention uses something the user “has” (a session code), something the user “knows” (a user credential such as a password) and something the user “is” (a biometric) to authenticate the identity of the user. In this way, the authentication server of the present invention advantageously can provide a relatively high level of certainty regarding the identity of the authenticated user.

Specifically, a system for authenticating a user on a computer network in accordance with the present invention includes a service provider, a client and an authentication server. The service provider provides a service to clients on the computer network. The client provides authentication information of the user prior to receiving services from the service provider. The authentication information includes at least a supplied user credential associated with the user of the client, a predetermined session code and an extracted biometric template representing biometric information associated with the user of the client. The authentication server verifies the identity of the user by analyzing the supplied user credential, the predetermined session code and the extracted biometric template.

### BRIEF DESCRIPTION OF THE DRAWINGS

FIG. 1 is a block diagram showing a distributed computer network having a client, a service and an authentication server in accordance with the present invention.

FIG. 2 is a flow chart illustrating steps taken by a user of the distributed computer network shown in FIG. 1 which are part of a method for entering into a contract in accordance with the present invention.

FIG. 3 is a flow diagram illustrating the steps the authentication server shown in FIG. 1 completes when it receives a contract to be authenticated from a user in accordance with the present invention.

FIG. 4 is a block diagram illustrating the components of the client shown in FIG. 1.

FIG. 5 is a block diagram illustrating the components of the authentication server shown in FIG. 1.

FIG. 6 is a block diagram illustrating the steps used by a client application program interface (“API”) run on the client shown in FIG. 1.

FIG. 7 is a block diagram illustrating the steps used by a server API run on the authentication server shown in FIG. 1.

### DETAILED DESCRIPTION

The present invention includes an authentication server which uses up to three distinct pieces of information or “metrics” to verify the identity of a user. First, the authentication server can use a biometric measurement of the user. This measurement is preferably a fingerprint image, however, it could also be any other biometric measurement such as an iris scan, voice print or face scan, to name a few. The authentication server preferably also uses a password which is known by the user. Finally, the authentication server preferably generates a session code and delivers it to the user prior to an authentication of the user. The session code can be a randomly generated string or other soft token and is preferably known by the authentication server but not by the user.

By using the three metrics discussed above, the authentication server of the present invention uses something the user “has” (the session code), something the user “knows” (the user credential) and something the user “is” (the biometric) to authenticate the identity of the user. Thus, in order for a second user to impersonate a first user, the second user would have to obtain the first user's session code, credential and biometric. This could be relatively more difficult that obtaining any one of these metrics. Therefore, the authentication server of the present invention advantageously can provide a relatively high level of certainty regarding the identity of the authenticated user.

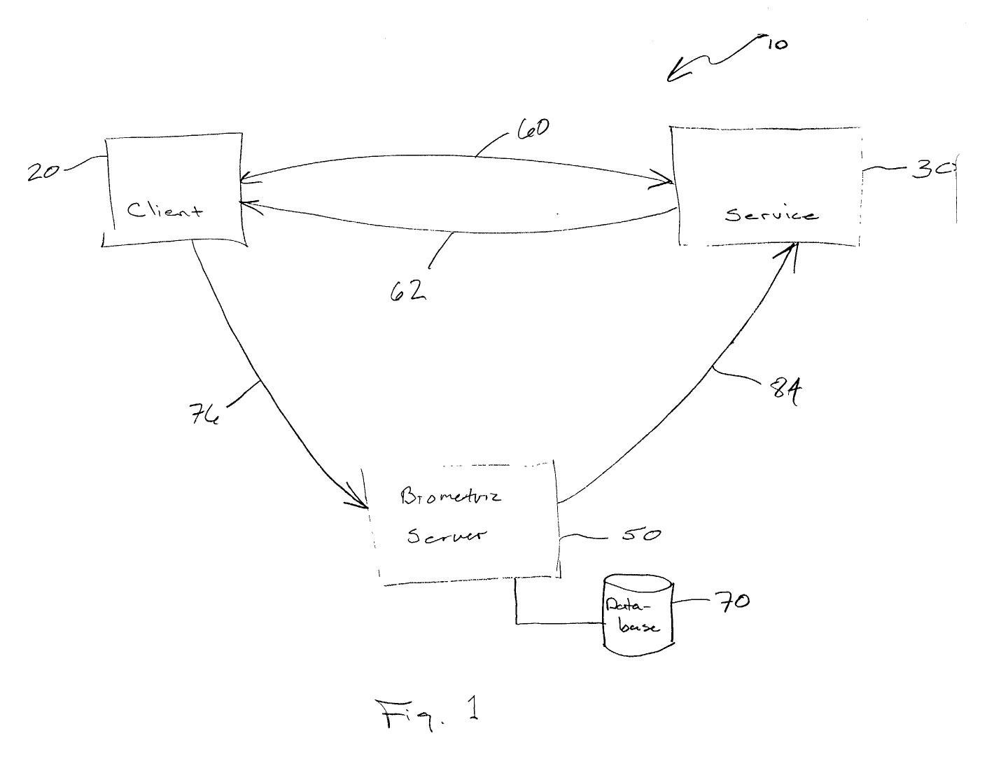

FIG. 1 is a block diagram illustrating a distributed computer network 10 including an authentication server in accordance with the present invention. Network 10 can be a LAN, WAN, the internet, or any other distributed computer network. Network 10 includes a client 20 to allow a user (not shown) to access network 10 and a service 30, interconnected to client 20 for providing an application service to client 20. Client 20 can be a PC, portable computer, or any other type of computing device. Service 30 can include one or more individual servers and can provide client access to network applications or services such as shopping, banking, stock trading and other “on-line” services. Network 10 also includes biometric authentication server 50, which will be discussed in greater detail below, interconnected to both user 20 and service 30. Interconnections connecting client 20, service 30 and authentication server 50 can be any type of computer network interconnections including, but not limited to, internet connection, Ethernet connections or wireless connections. The interconnections do not need to be of the same types. As shown, network 10 may, but does not necessarily, also include one or more external databases 80 which houses user authentication information and will be discussed in greater detail below.

In a first embodiment of the present invention, an authentication server 50 authenticates or certifies the identity of a user (not shown) of client 20 who wishes to enter into a contractual relationship with service 30. It is also considered that the method and apparatus of the present invention can be used to allow the user of client 20 to enter into other types of transactions with service 30, such as purchases, stock trades, on-line banking and so on.

A first embodiment of the steps used to provide a multiple metric authentication is shown in FIG. 1. In step 60, a connection is established between service 30 and client 20. This connection may be secure (such as through the use of Secure Sockets Layer (“SSL”) protocol) but need not be. In step 62, service 30 forwards a contract to the client to be digitally signed by the user. Preferably, the contract is encrypted with the private key of service 30 and client 20 already possesses the public key of service 30. The user can then decrypt the contract, using the public key of service 30, read the contract and determine whether he or she wishes to digitally sign it.

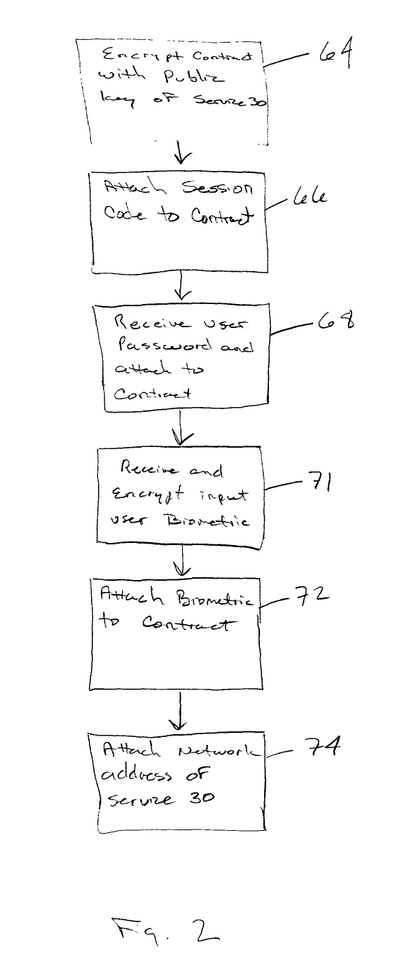

If the user wishes to sign the contract he or she can access a program on the client which, as shown in FIG. 2, performs a number of steps. First, in step 64, after client 20 reviews the contract, the contract is preferably encrypted with the public key of service 30 which the client 20 has previously obtained. This serves to keep the contents of the contract secret during certification by authentication server 50. Next, in step 66, a session code is preferably attached to the contract. The session code is preferably a random character string or other soft token which is generated by authentication server 50 in a manner understood by those skilled in the art and forwarded to, and preferably stored on, client 20 after a previous authentication session. It is also contemplated that a server separate from the authentication server 50, and attached thereto, generate the session code. Prior to the first certification session by any user of client 20, a session code can be provided to a user of client 20 when client 20 enrolls for certification services. The initial session code can be provided on a floppy disk or by some other means to be stored on client 20. Preferably, the authentication server 50, or separate session code server, generates a different session code for each certification session. After generating the session code for a given transaction, authentication server 50 associates the session code with the user to whom it was issued and stores the session code and association in a database interconnected with authentication server 50. The user can be identified by a username or other unique user ID. The username is preferably provided to authentication server 50 at the time the client 20 enrolls for certification services with authentication server 50. A standard relational database, such as Microsoft® Access 2000® can be used to associate the username with a session code.

In addition to requesting a session code, the client program preferably requests that the user of client 30 also enter a password or user credential. The password can be assigned to the user at enrollment and, if desired, changed by the user at a later time. The password can also be any other user credential such as, without limitation, a user ID or token. The certification server 50 associates the password with the enrolled user of client 20 as discussed in detail below. As shown in step 68, after the password is entered, the client program attaches the password to the contract in a known manner. Next, the client program requests that the user enter biometric information, such as a fingerprint, face scan, retinal scan, voice print or other biometric identifier. As discussed below, the client preferably includes a biometric input device such as a fingerprint scanner. In Step 71, the input biometric is preferably encrypted by the client program. Preferably, a symmetric or PKI encryption scheme, as known in the art, is used to encrypt the input biometric. Then, in step 72, the client program attaches the encrypted biometric to the contract. Preferably, as shown in step 74, the client program can also attach to the contract the network address, the internet protocol (IP) address for example, of the service 30. In this way, the network location to which the authentication server 50 must forward the certified contract is provided to authentication server 50.

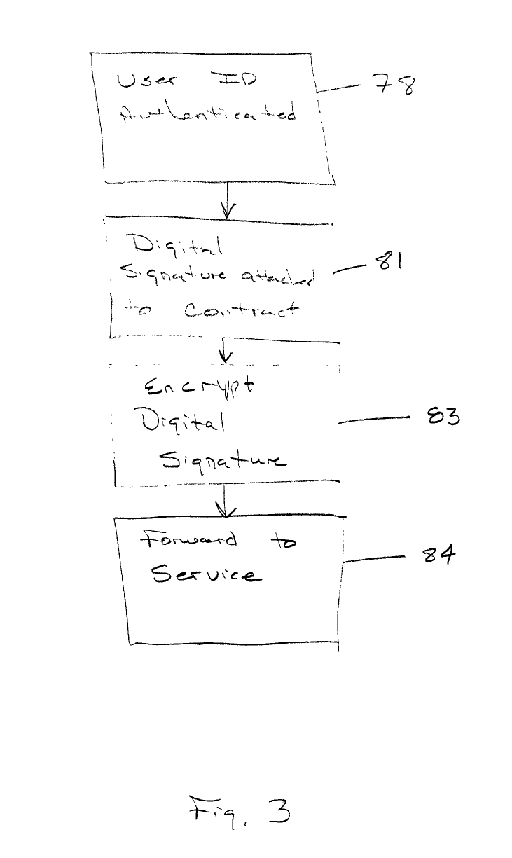

Referring again to FIG. 1, in step 76, the client software forwards to the authentication server 50 the encrypted contract, the session code, the user's password, the user's encrypted biometric, and, if necessary, the network location of the service 30. Referring now to FIG. 3, which shows the steps authentication server 50 completes when it receives a contract to be authenticated from a user, in step 78, as will be discussed below, when the authentication server 50 receives the above information, it authenticates the user of client 20. It does this using all three identifiers: the session code, the user's password, and the user's biometric.

If the identity of the user of client 20 is successfully authenticated in step 78, authentication server 50 certifies the contract and forwards the certified contract to the service 30. As shown in step 81, this certification is preferably accomplished by attaching a digital signature to the contract. The digital signature preferably includes a character string which is associated with the password, biometric template and/or session code of the authenticated user. It is also within the ambit of the present invention, however, that the digital signature include the biometric template of the authenticated user, that is, information which corresponds to a users biometric information, such as a fingerprint. In step 83, this digital signature is preferably encrypted with a private key of the authentication server. When the service 30 receives the certified contract, the signature can be decrypted with the public key of authentication server 50 which may be previously provided to service 30.

FIG. 4 is a block diagram of client 20. Preferably, client 20 includes web browser 22 for use in connecting with and communicating with a service 30 over the Internet. Client 20 also preferably includes authentication software 24 interconnected with web browser 22 and biometric input device 28 for allowing a user to input biometric information, such as a fingerprint, to allow identity authentication. Device driver 26 for driving biometric input device 28 is interconnected with authentication software 24 and biometric input device 28. Various types of biometric input devices are known in the art. One such device, a device for the input of a users fingerprint, is disclosed in U.S. Pat. No. 6,324,020 to Teng et al. for Method and Apparatus for Reduction of Trapezoidal Distortion and Improvement of Image Sharpness in an Optical Image Capturing System which is hereby incorporated in its entirety by reference.

Authentication software 24 is for activating biometric input device 28, through device driver 26 and collecting and processing biometric information obtained from biometric input device 28. Specifically, when browser 22 receives a request from service 30 for biometric authentication of a user of client 20, as for example when service 30 forwards a contract to client 20, this request is forwarded to authentication software 24. Authentication software 24 then activates biometric input device 28 via device driver 26.

At the same time, authentication software 24 can request that the user of client 20 input biometric information using biometric input device 28. Preferably, client 20 is a standard personal computer having a CPU, keyboard and monitor. The request for biometric input can be made via the monitor. Additionally, instructional feedback can be provided during user input of biometric information via the monitor to facilitate input of high quality biometric data. As discussed in detail below, authentication software 24 contains an application programming interface (API) which processes the biometric data input by the user of client 20 to prepare the data to be sent to biometric authentication server 50. Software capable of activating a biometric input device and collecting and processing biometric information is available from, for example, Secugen® Corporation of Milpitas, Calif. under the name SecuDeskTop®.

In addition to processing input biometric data, authentication software 24 performs a number of additional steps. Authentication software 24 encrypts the contract with the service's public key. Authentication software 24 then constructs a data package including the encrypted contract, the digital session code, a password belonging to the user of the client, the biometric data input by the user and processed by authentication software 24, and, if necessary, the location of service 30 on the network, so that the authentication server 50 can forward the signed, authenticated contract back to service 30 where it originated. As noted above, it is also considered that service 30 query authentication server 50 to retrieve the signed contract or otherwise retrieve user identity verification information.

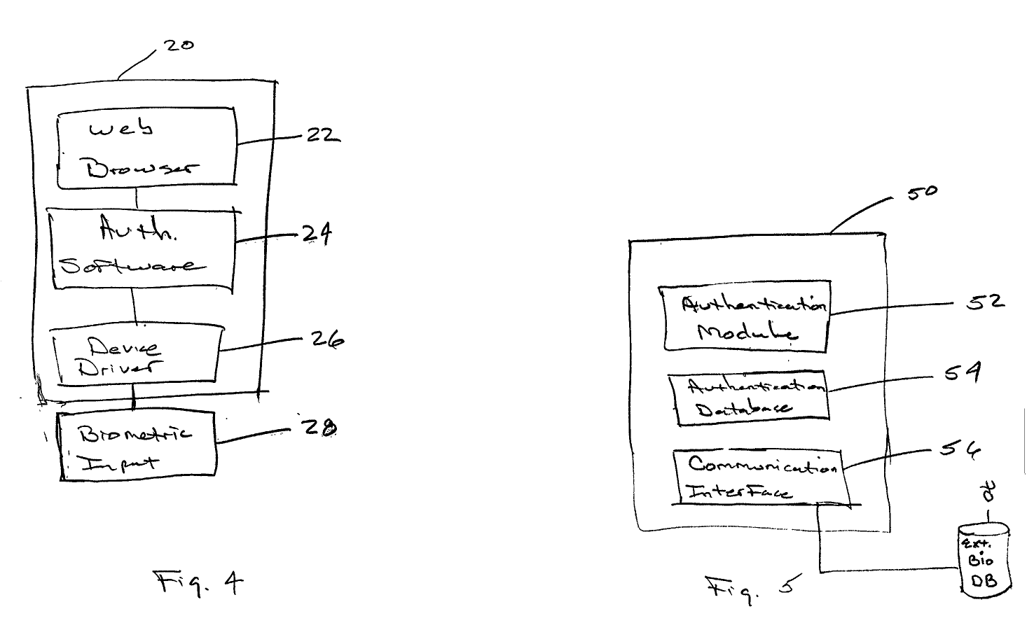

FIG. 5 is a block diagram showing the components of authentication server 50. Authentication server 50 includes authentication module 52, for carrying out and controlling the authentication process, and database 54 which stores biometric, user digital certificate, and, if necessary, other identification data. Biometric authentication server 50 can also communicate with one or more remote databases 70 via a communications interface 56. Remote databases 70 can also store biometric, certificate, and other identification data. Databases 54 and 70 can be a standard relational database such as Microsoft® Access 2000®.

The data package prepared and sent by client software 24 is received in authentication server 50 by authentication module 52. Authentication module 52 authenticates the identity of the user of client 20 using all three metrics forwarded by client 20. Specifically, and as discussed in detail below, authentication module 52 uses the user's biometric data, password, and the session code to authenticate the identity of the user of client 20.

As discussed in detail below, authentication module 52 compares the biometric data or “template” created by authentication software 24 in client 20 with a biometric template which has been previously provided by the user of client 20 in a separate enrollment process. This template is stored either in the dedicated authentication database 54 or external authentication database 60 which is accessed by authentication module 52 via communication interface 56. The identification information provided by client 20 preferably includes indicator flags which provide information about the location of data in the databases 54 and 70 where a biometric template corresponding to the user of client 20 will be stored. If the biometric template is stored in dedicated database 54, then authentication module 52 queries dedicated database 54.

However, if the indicator flag provides that the appropriate template is located in remote database 70, then this information is transmitted to communication interface 56. Communication interface 56 establishes a communication link with remote database 70 and queries remote database 70 for the required template. Communication interface 56 then retrieves the appropriate template. Whether the appropriate template is located in dedicated database 54 or remote database 70, authentication module 52 places the template in a temporary buffer. As discussed in detail below, authentication module 52 then compares it to the user input template. If the two templates match within predetermined parameters, then the identity of the user is biometrically authenticated.

Authentication module 52 also verifies, in a known manner, that the password sent by client 20 matches a password previously entered by the user and stored preferably in dedicated authentication database 54. Finally, authentication module 52 verifies that the session code forwarded by client 20 is correct. Preferably, the session code and password are each simply a character string. Thus, the authentication module 52 preferably verifies the correctness of the session code by simply matching two character strings. If all three metrics are verified, then authentication server 50 verifies the identity of the user of client 20. If one or more of the metrics do not match, authentication server cannot verify the identity of the user of client 20. This authentication information can either be retrieved by service 30 or forwarded to service 30 by authentication server 50.

As noted above, service 30 and the user of client 20 may be entering into a contractual relationship. If this is the case, then it is considered that either databases 54, 70, or another dedicated or remote database of authentication server 50 contain a digital certificate for the user of client 20. Preferably, this digital certificate was stored in the authentication server at the time the user of client 20 enrolled his or her stored biometric template. If the authentication information resulting from matching of the three metrics, biometric template, password and session code, is positive (that is, user identity is verified) then authentication server 50 preferably “signs” the digital contract using the user's digital certificate.

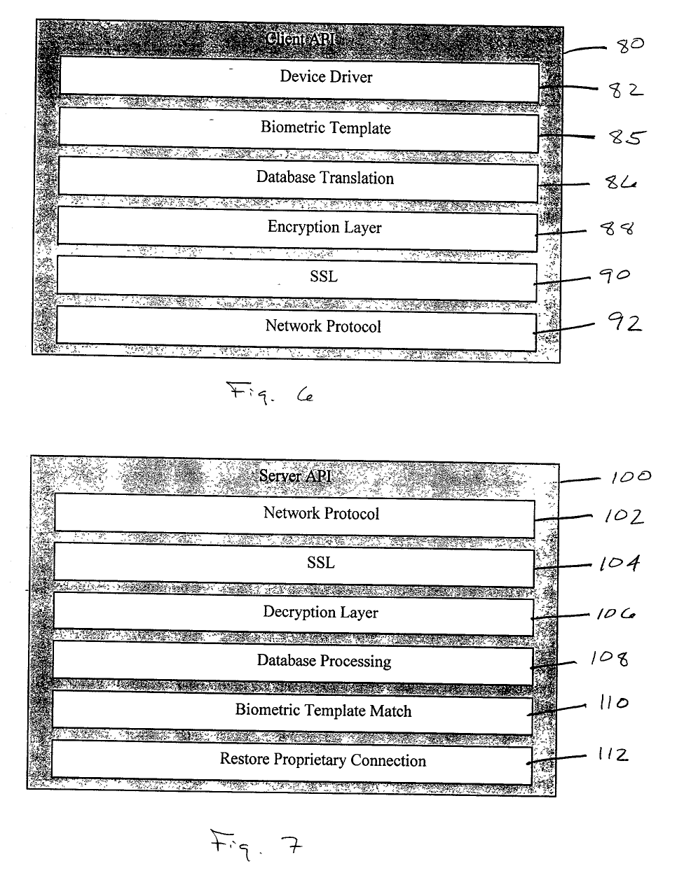

FIG. 6 is a detailed block diagram of a preferred embodiment of client API 80, which is preferably part of authentication software 24 of client 20. Client API 80 activates biometric input unit 28 and generates an encrypted biometric template in response to an input from the browser 22 when service 30 requests that the user of client 20 verify his or her identity. First, client API 80 contains a device driver which activates and drives the biometric input unit 28. As noted above, when biometric input unit 28 is activated, the user of client 20 is preferably alerted to input biometric information via a user interface screen on a client monitor. After the user has input biometric information via biometric input unit 28, in step 85 client API 80 creates a template from the biometric information. For example, if a fingerprint scanner is used as the biometric input device 28, then the template is generated based on the type and spatial relationship of the minutia of the fingerprint used as the biometric input. Creation of such templates from biometric fingerprint, voice, face, eye, etc. information is well known in the art.

In step 86, client API 80 formats the template for the appropriate protocol for databases 54 or 70 of authentication server 50. In step 88, client API 80 encrypts the template. This allows for a higher level of security when transmitting the template from client 20 to authentication server 50. Next, in step 90, the encrypted template is formatted for transmission over the network. The formatting of the encrypted template is dependent on the type of network over which the template will be transmitted. For example, the template would be formatted differently for a LAN than it would be for a WAN or the Internet. Finally, for additional security, in step 92 the network formatted, encrypted template is preferably transmitted over the network to authentication server 50 using SSL.

FIG. 7 is a block diagram showing the details of the server API 100 which is preferably part of authentication module 52 contained in authentication server 50. As shown in steps 102 and 104, the template is received by server API 100 using SSL and the appropriate network protocol, respectively. In step 106, the template, which was encrypted in step 88 of FIG. 6 is decrypted. In step 108, server API 100 performs a database translation, if necessary. In step 110, the appropriate template that is stored in database 54 or 70 is retrieved and compared to the received template. The stored template which is matched against the received template is preferably located in the database using a user identification code. It is also contemplated that the database 54 or 70 directly search the stored templates for a matching template, and then determine whether a name associated with the received template in the database matches the received username.

To match the received template, server API 100 preferably uses an image processing matching algorithm. Preferably, the type of biometric used is a fingerprint image and, therefore, the type of matching algorithm used is preferably a fingerprint matching algorithm. Generation of a fingerprint template from a fingerprint image is well understood in the art and generally involves standard image processing techniques which use an algorithm to translate fingerprint image information into a unique character string. An example of such an algorithm is disclosed in co-pending U.S. patent application Ser. No. 09/994,173 for Method for Extracting Fingerprint Feature Data using Ridge Orientation Model which is incorporated herein in its entirety by reference. Because the fingerprint template is preferably a character string, matching the fingerprint template retrieved from a user with a template stored in the authentication server preferably involves only matching the two character strings representing each template. Finally, in step 112, verification of a fingerprint match is made or not made.

The foregoing descriptions of specific embodiments of the present invention have been presented for purposes of illustration and description. They are not intended to be exhaustive or to limit the invention to the precise forms disclosed, and it should be understood that many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. Many other variations are also to be considered within the scope of the present invention.

What is claimed is:

1. An method of authenticating identity of a user of a client on a computer network including:
extracting a biometric template from the user;
bundling the extracted biometric template with a supplied user credential and predetermined session code;
providing the extracted biometric template, supplied user credential and predetermined session code to an authentication server;
comparing the extracted biometric template, supplied user credential and predetermined session code with, respectively, a registered biometric template, a registered user credential and a session code stored in the authentication server.

2. The method of claim 1 further including:
generating a new session code in the authentication server, the new session code different from the predetermined session code; and
forwarding the new session code to the client to be used during a subsequent transaction.

3. The method of claim 2 further including storing a copy of the new session code in the authorization server.

4. The method of claim 3 further including providing a positive authentication response to a service requesting user authentication on the condition that the extracted biometric template match the registered biometric template, the supplied user credential match the registered user credential and the predetermined session code match the session code stored in the authentication server.

5. The method of claim 4 wherein extracting the extracted biometric template includes:
providing a biometric input device connected to the client;
inputting biometric information from the user into the biometric input device.

6. The method of claim 5 wherein bundling the extracted biometric template with the supplied user credential and predetermined session code is completed by the client.

7. The method of claim 6 wherein bundling the extracted biometric template with the supplied user credential includes bundling the extracted biometric template with a user ID, password or token.

8. The method of claim 7 wherein inputting biometric information from the user includes inputting user fingerprint information.

9. A system for authenticating a user on a computer network including:
a service provider for providing a service to clients on the computer network;
a client for providing authentication information prior to receiving services from the service provider, the authentication information including at least a supplied user credential associated with the user of the client, a predetermined session code and an extracted biometric template representing biometric information associated with the user of the client; and
an authentication server for verifying the identity of the user by analyzing the supplied user ID, the predetermined session code and the extracted biometric template.

10. The system of claim 9 wherein the predetermined session code is generated by the authentication server and provided to the client to the used during an authentication transaction.

11. The system of claim 10 wherein;
the supplied user credential is entered into the client by the user;
the predetermined session code is provided by the client to the authentication server;
the extracted biometric template is generated from biometric information entered by the user into the client computer; and
the supplied user credential, the predetermined session code and the extracted biometric template are each forwarded to the authentication server from the client.

12. The system of claim 11 further including at least a registered user credential, a session code stored in the authentication server and a registered biometric template each stored in the authentication server and each associated with the user of the client wherein the authentication server will compare the supplied user credential with the registered user credential, predetermined session code with the session code stored in the authentication server and the extracted biometric template with the registered biometric template.

13. The system of claim 12 further including a fingerprint input device connected with the client and wherein the extracted biometric template and the registered biometric template are each fingerprint templates.
